(19) United States
(12) Patent Application Publication
(10) Pub. No.: US 2017/0062914 A1
(43) Pub. Date: Mar. 2, 2017

(54) ANTENNA DEVICE

(71) Applicants: Yoshinori MASAKA, Katagami-shi (JP); Junichi NORO, Akita-shi (JP)

(72) Inventors: Yoshinori MASAKA, Katagami-shi (JP); Junichi NORO, Akita-shi (JP)

(73) Assignee: MITSUMI ELECTRIC CO., LTD., Tokyo (JP)

(21) Appl. No.: 15/227,686

(22) Filed: Aug. 3, 2016

(30) Foreign Application Priority Data
Aug. 26, 2015 (JP) 2015-166602

(51) Int. Cl. H01Q 1/32; H01Q 1/36; H01Q 1/48

(52) U.S. Cl. CPC H01Q 1/3275; H01Q 1/48; H01Q 1/362

(57) ABSTRACT

An antenna device includes an antenna base, an antenna cover attached to the antenna base and an antenna unit. The antenna base includes a metallic die-cast base and a resin base. The die-cast base includes a protrusion which is to be inserted in a fixing opening formed in a vehicle and attached to the vehicle, and the die-cast base and the resin base are molded integrally.

### BACKGROUND OF THE INVENTION

1. Field of the Invention

The present invention relates to an antenna device.

2. Description of the Related Art

Conventionally, there has been known an on-vehicle antenna device (shark fin antenna) which is called the shark fin shaped antenna due to its external appearance having a shape like a shark's fin (see Japanese Unexamined Patent Application Publication (Translation of PCT Application) No. 2009-514253). With respect to such antenna device, an antenna such as a GPS (Global Positioning System) is disposed on a base and a housing cover having a shark fin shape is attached to the base so as to include the antenna inside thereof.

As a shark fin antenna, there is also known an antenna device having a single die-cast base which is formed by metal die casting. However, if the entire base is formed by die casting, the antenna device becomes heavy and the cost will also be expensive.

In view of the above, as a shark fin antenna, there is also known an antenna device having a base which is formed by molding sheet metal components and resin together (see Japanese Unexamined Patent Application Publication No. 2014-68192). However, since sheet metal components have low rigidity and there are great number of sheet metal components, it is difficult to form a complicate shape.

In view of the above, as a shark fin antenna, there is also known an antenna device having a base which holds a metallic conductive base inside the surrounding wall unit of an insulated based (see Japanese Patent Publication No. 5654917).

However, since the conductive base is embedded in the insulated base in the antenna device of JP 5654917, strength of the connection between the insulated base and the conductive base is weak and there is a possibility that the connection be loose due to long period vibration and the like. In the antenna device of Japanese Patent Publication No. 5654917, there is also a possibility that an invasive object such as water come inside the antenna through a space between the conductive base and the insulated base. Further, since the conductive base and the insulated base are screwed together, there is a possibility that an invasive object from the outside come inside through the space of the screw holes.

### SUMMARY OF THE INVENTION

It is, therefore, a main object of the present invention is to improve the strength of an antenna device, reduce the weight and cost of the antenna device and to prevent an invasive object from coming inside thereof.

In order to achieve the above object, according to an aspect of the present invention, there is provided an antenna device including:

an antenna base;

an antenna cover attached to the antenna base; and

an antenna unit, wherein

the antenna base includes a metallic die-cast base and a resin base,

the die-cast base includes a protrusion which is to be inserted in a fixing opening formed in a vehicle and attached to the vehicle, and

the die-cast base and the resin base are molded integrally.

Preferably, in the antenna device, the protrusion is grounded by being attached to the vehicle, the antenna device includes an antenna board which is electrically connected to the antenna unit, the die-cast base includes a board holder which holds the antenna board, and the board holder is grounded via the protrusion.

Preferably, in the antenna device, the resin base includes a plurality of concave units, and the plurality of concave units are arranged so that a resin part between the plurality of concave units functions as a reinforcement unit.

Preferably, in the antenna device, the antenna device includes a gasket which is provided around the resin base and which deforms by a pressure of when attaching the protrusion to the vehicle.

Preferably, in the antenna device, the antenna device includes a packing which is provided on a back of the antenna base so as to surround the protrusion and a joint border between the die-cast base and the resin base and which deforms by a pressure of when attaching the protrusion to the vehicle.

Preferably, in the antenna device, the antenna cover includes:

a resin cover body; and

a capacitive element, at least apart of the capacitive element being embedded in the cover body, and

the antenna unit includes:
a helical element; and
a contact connector which connects the helical element and the capacitive element.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is an external view of an antenna device according to an embodiment of the present invention;

FIG. 2 is a cross-sectional view of the internal structure of the antenna device;

FIG. 3 is a developed view of an antenna base, a gasket and a packing;

FIG. 4A is a perspective view of the antenna base, gasket and packing seen from above; and

FIG. 4B is a plan view of the antenna base, gasket and packing seen from below.

### DESCRIPTION OF THE PREFERRED EMBODIMENTS

Hereinafter, an embodiment of the present invention will be described with reference to the drawings. However, the present invention is not limited to the examples shown in the drawings.

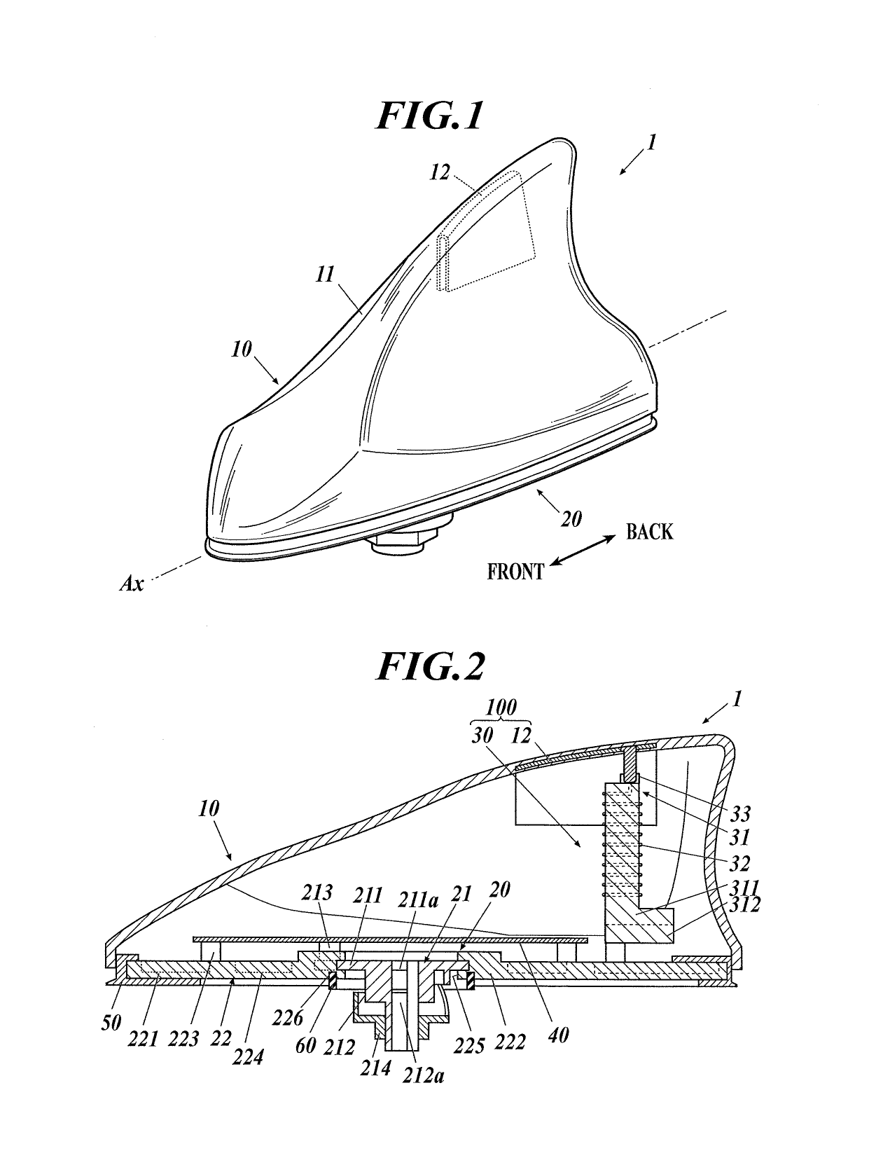

FIG. 1 is an external view of an antenna device 1 according to the embodiment. FIG. 2 is a cross-sectional view of the internal structure of the antenna device. The antenna device 1 of the embodiment is an antenna device which can receive radio waves of a frequency band for AM/FM broadcasting. For example, the antenna 1 is an on-vehicle antenna device which is mounted and fixed to the mounting surface on the roof of a vehicle.

As shown in FIGS. 1 and 2, the antenna device 1 includes an antenna cover 10, an antenna base 20, an antenna unit 30, an antenna board 40, a gasket 50 and a packing 60. The antenna unit 30 is part of an antenna to receive radio waves from AM/FM broadcast stations.

As shown in FIG. 1, the antenna cover 10 includes a cover body 11 and a capacitive element 12. The cover body 11 has a streamlined shape that flares laterally and bulges upward toward the rear along the longitudinal central axis Ax. The cover body 11 thus has a low-profile shark fin shape which in good coordination with the external appearance of the vehicle.

The cover body 11 is a molded product composed of radio wave transmissive and insulating synthetic resin, such as acrylic resin, and has an open bottom surface. Fixing the antenna base 20, the gasket 50 and the packing 60 to the bottom surface of the cover body 11 defines a space accommodating the antenna unit 30.

The capacitive element 12 is an antenna element composed of metal, such as copper and tin plate. The capacitive element 12 is formed by a metallic plate being arbitrarily bent by press molding using a mold for forming the capacitive element 12 into a shape corresponding to the shape of the cover body 11. The upper part of the capacitive element 12 is embedded in the cover body 11 due to integral molding. The capacitive element 12 has a connection unit to be connected with the after-mentioned contact connector 33 and the connection unit and the part which is not integrally molded are exposed from the inner surface of the cover body 11.

The antenna cover 10 is manufactured through integral molding (insert molding) involving placing the capacitive element 12 in to a mold of the cover body 11, injecting synthetic resin in to the mold, and hardening the resin. With respect to the antenna cover 10, the substantive height of the antenna element can approximate the height which is the limited maximum height in terms of design by integrally molding the cover body 11 and the capacitive element 12, and the receiving sensitivity of radio waves can be improved.

Here, a part of the capacitive element 12 is integrally molded with the cover body 11 and a part of the capacitive element 12 is embedded in the cover body. However, such configuration is not limitative in any way. For example, almost all of the capacitive element except for the connection unit may be integrally molded with the cover body and the above mentioned almost all of the capacitive element may be embedded in the cover body. Further, the cover body may have a concave unit for embedding the capacitive element inside thereof, the capacitive element may be housed in the concave unit of the cover body and at least a part of the exposed part of the capacitive element may be covered with the resin which is the same as the resin used to form the cover body so that at least a part of the capacitive element be embedded in the cover body.

The antenna unit 30 and the capacitive element 12 are collectively referred to as an antenna 100. The antenna 100 receives radio waves from AM/FM broadcasting stations. The capacitive element 12 functions as a capacitance hat and an inductor of the antenna 100.

As shown in FIG. 2, the antenna base 20 includes a die-cast base 21 and a resin base 22. The die-cast base 21 includes a base member 211, a protrusion 212 and a board holder 213. The die-cast base 21 is formed integrally as a metallic die-cast such as ZDC1 (an alloy of Zn—Al—Cu system), ZDC2 (an alloy of Zn—Al system) etc. The base member 211 is formed in an approximately plan shape that matches the open bottom surface of the antenna cover 10. The protrusion 212 is a member which is to be inserted in the fixing opening (not shown in the drawing) formed in the mounting surface of the vehicle roof to fix the antenna device 1.

The protrusion 212 is formed in a male screw shape as a bolt and the protrusion 212 has a groove 212a along the axis direction thereof. A cable (not shown in the drawing) which is electrically connected with an internal vehicle equipment (not shown in the drawing) installed inside the vehicle is inserted in the groove 212a. The internal vehicle equipment at least includes a receiver which receives reception signals corresponding to radio waves of AM/FM broadcastings from broadcasting stations. The cable is a coaxial cable, for example. Thus, the base member 211 communicates with the groove 212a and includes a hole 211a in which the cable is inserted.

A female screw unit having an axis in the direction perpendicular to the upper surface of the base member 211 is formed in each board holder 213. The antenna board 40 sandwiched and held by being fixed with screws from above.

In the state where the protrusion 212 is being inserted in the fixing opening, the antenna device 1 is set and fixed on the mounting surface by sandwiching the mounting surface of the roof by fastening the fixing member 214 to the protrusion 212 from inside the vehicle. At this time, the die-cast base 21 is electrically connected with the mounting surface and is grounded via the body of the the vehicle. The fixing member 214 is a fixing member for attaching a traditional on-vehicle antenna which includes a nut and a fixing part which is formed in a cylindrical shape whose radius being larger than that of the nut, the axis of the nut being the center, and which has a protrusion for being in contact with the mounting surface from inside and fixing the antenna.

The resin base 22 is made of resin such as ABS (Acrylonitrile Butadiene Styrene) or the like and is molded integrally with the die-cast base 21. The resin base 22 includes a flat plate 221 and a die-cast attaching unit 222. The plan surface of the flat plate 221 is arranged so as to be parallel with the plan surface part of the base member 211 and a plurality of holding units 223 and concave units 224 are formed on the upper surface thereof. With respect to the holding units 223, female screw units having axes that are perpendicular to the upper surface of the flat plate 221 are formed therein. The holding units 223 hold the antenna board 40 and the after-mentioned antenna block 31 by screwing from above.

The die-cast attaching unit 222 is a flat plate to which the die-cast base 21 is attached. The die-cast attaching unit 222 includes a hole 225 for the die-cast base 21 and includes an attachment groove 226 for attaching the packing 60 on the bottom thereof.

The antenna cover 10 is attached to the antenna base 20 by being screwed to the female screw unit which is formed at the boss which is formed on the inner surface of the cover body 11 from the back of the resin base 22, for example.

The antenna unit 30 includes an antenna block 31, helical element 32 and a contact connector 33.

The antenna block 31 is composed of insulating resin such as ABS and the like, and includes an L-shaped part 311 and a base part 312. The L-shaped part 311 is formed in a L-shape which stands to be seen as an L-shape along the longitudinal central axis Ax. The L-shaped part 311 is arranged on the base part 312 so that the longitudinal direction thereof be perpendicular to the plan surface of the antenna base 20 and the longitudinal central axis Ax. The rectangle part of the L-shaped part 311 in the longitudinal direction (in the direction perpendicular to the longitudinal central axis Ax) has a conducting wire which is the helical element 32 being wound around in a helical manner with the longitudinal direction of the L-shape as the axis. The rectangle part of the L-shaped part 311 in the longitudinal direction has a groove or grooves formed thereon for winding the helical element 32 around, for example. Further, the rectangle part of the L-shape part 311 in the lateral direction (in the direction of longitudinal central axis Ax) reinforces the rectangle part of the L-shape part 311 in the longitudinal direction. When attaching the antenna block 31, the rectangle part of the L-shape part 311 in the lateral direction prevents the antenna block 31 from being attached to the plan surface of the antenna base 20 in an abnormal angle. A female screw unit or a hole is formed in the base part 312, and the base part 312 is held on the holding units 223 by being screwed from above.

The helical element 32 is an antenna element of a conducting wire wound around the antenna block 31 in the up and down directions with a predetermined pitch therebetween in the helical manner. The conducting wire of the helical element 32 is an enamel wire of 1.0 mm outer diameter to which insulation coating is performed, for example, due to its easy to prepare, easy to process and isolation property. One end of the helical element 32 is electrically connected with the power feeding point of the antenna board 40 and the other end is electrically connected with the contact connector 33. In such way, the antenna unit 30 has the configuration of middle load where the helical element 32 is disposed and connected midway between the capacitive element 12 and the power feeding point of the antenna board 40.

The contact connector 33 is composed of soft metal such as tinned brass and is a connector formed in an M-shape. The contact connector 33 holds the connection part of the capacitive element 12 therein so that the contact connector 33 is electrically connected to the capacitive element 12.

In such way, the antenna 100 is configured as an AM/FM radio antenna by the capacitive element 12, the contact connector 33 and the helical element 32 being connected in series in this order. The length of the helical element 32 is determined such that the capacitive element 12, the contact connector 33 and the helical element 32 are arranged to have an antenna length (for example, ¼ wavelength) that resonates in a frequency band (76 to 108 MHz) for FM broadcasting. It should be noted that the length of the helical element 32 is determined in consideration of the effect of the capacitance of the capacitive element 12 on a reduction in length of the helical element 32 described below and the effect of the pitch of the helical element 32 on a reduction in frequency. The antenna 100 functions as a non-resonant antenna in a frequency band for AM broadcasting.

The capacitive element 12 functions as a capacitance hat to generate capacitance between the capacitive element 12 and the contact surface of the vehicle roof. This capacitive element 12 can reduce the height of the antenna 100 while preventing a reduction in receiving efficiency of the antenna device 1. The resonant frequency of the helical element 32 is controlled by the length of the helical element 32, and is matched to the frequency band for FM broadcasting. The helical element 32 also functions as an inductor. As the pitch of a helical element decreases, the Q-value increases. The helical element 32 is therefore wound at an optimal pitch and at equal intervals to provide a predetermined Q-value.

Preferably, the helical element 32 is wound at a pitch of 2 mm or greater. This is to reduce the Q value and to increase the bandwidth. As described above, to improve antenna performance, for example, to facilitate tuning and to enhance the receiving sensitivity, the pitch of the helical element 32 and the height of the antenna 100 should preferably be increased as much as possible.

Alternatively, the helical element 32 may be wound at different pitches. For example, the pitches may gradually vary along the axial direction of the helical element 32. Such partial variations in pitch of the helical element 32 can readily control the resonant frequency of the antenna 100, and can simplify the manufacture of the antenna 100.

The antenna board 40 is a circuit substrate such as a PCB (Printed Circuit Board) which is set on the upper surface of the die-cast base 21 and the resin base 22 and fixed thereto by being screwed, for example, including a tuning circuit and an amplifying circuit for selectively receiving only the radio wave of a specific frequency for antenna 100. The antenna board 40 is electrically connected with the antenna 100 (helical element 32) and the cable for the antenna unit 30 (not shown in the drawings).

The gasket 50 is composed of an elastic body having water proof and chemical resistive properties, for example, petroleum-derived rubber such as EPDM (Ethylene Propylene Diene Monomer). The gasket 50 is arranged around the resin base 22. The gasket 50 prevents an invasive object such as water from coming inside the antenna cover 10 and inside the vehicle by being sandwiched between the resin base 22 and the roof by the protrusion 212 being inserted in the fixing opening of the vehicle and being fastened by the fixing member 214. In such way, the inside can be maintained watertight.

The packing 60 is a waterproof packing composed of an elastic body such as urethane foam. The packing 60 has a cylindrical shape and is attached on the bottom of the resin base 22, the axis of the protrusion 212 being the center. In such way, the packing 60 is arranged so as to surround the joint border between the die-cast base 21 and the resin base 22 and to surround the protrusion 212 (and the fixing opening). The packing 60 is also sandwiched between the resin base 22 and the roof by the protrusion 212 being inserted in the fixing opening of the vehicle and being fastened by the fixing member 214. By using the packing 60 in addition to the gasket 50, an invasive object such as water can be more prevented from coming inside the antenna cover 10 and inside the vehicle. In such way, the inside can be maintained more watertight.

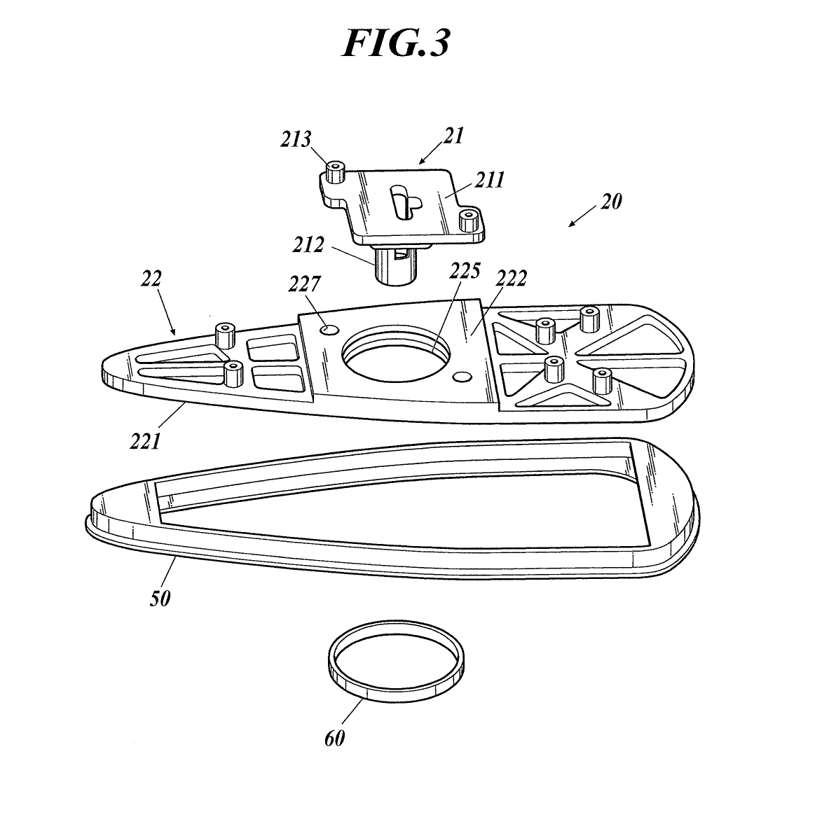

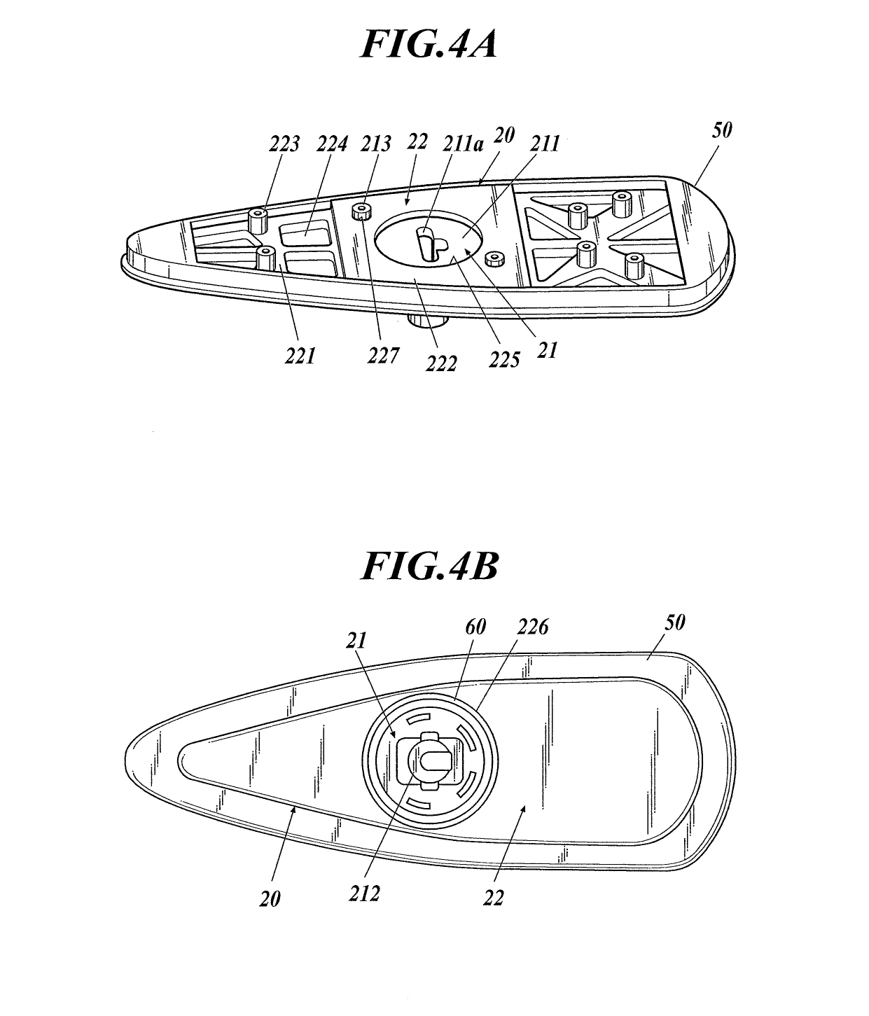

Next, with reference to FIGS. 3 and 4, the configuration of the antenna base 20 will be described in more detail. FIG. 3 is a developed view of the antenna base 20, the gasket 50 and the packing 60. FIG. 4A is a perspective view of the antenna base 20, the gasket 50 and the packing 60 seen from above. FIG. 4B is a plan view of the antenna base 20, the gasket 50 and the packing 60 seen from below.

As shown in FIG. 3, with respect to the antenna base 20, the die-cast base 21 and the resin base 22 are molded integrally. The antenna base 20 is manufactured, for example, by placing the die-cast base 21 in the mold for the resin base 22 and injecting resin therein and hardening the resin. The resin base 22 includes holes 227 for the board holders 213 Due to the die-cast base 21 and the resin base 22 being molded integrally, the die-cast base 21 and the resin base 22 can be connected more tightly, the space therebetween being reduced, and it is more tolerant to long period vibration comparing to the fitting configuration.

As shown in FIG. 4A, with respect to the integrally molded antenna base 20, the base member 211 including the hole 221a is exposed from the hole 225 so as to be seen from the upper surface of the die-cast attaching unit 222 and the board holders 213 are exposed from the holes 227 to the upper surface of the die-cast attaching unit 222. By attaching the antenna device 1 to the vehicle, the board holders 213 are grounded by being connected to the contact surface of the vehicle roof via the die-cast base 21. Since a plurality of concave units 224 are formed in the flat plate 221, the weight thereof can be reduced. Further, the plurality of concave units 224 are arranged so that the resin part between the concave units 224 functions as a reinforcement unit. Thus, the resin base 22 is reinforced by the resin part between the plurality of concave units 224.

With respect to the integrally molded antenna base 20, the gasket 50 is attached around the resin base 22. As shown in FIG. 4B, the packing 60 is also attached at the edge of the attachment groove 226 of the resin base 22.

As described above, according to the embodiment, the antenna device 1 includes the antenna base 20, the antenna cover 10 which is attached to the antenna base 20 and the antenna unit 30. The antenna base 20 includes the metallic die-cast base 21 and the resin base 22. The die-cast base 21 includes the protrusion 212 which is to be inserted in the fixing opening formed in the vehicle and attached thereto. The die-cast base 21 and the resin base 22 are molded integrally.

Thus, comparing to the case where a part of the antenna base is composed of sheet-metal parts, the connection between the die-cast base 21 and the resin base 22 can be prevented from loosening due to long period vibration and the like and the antenna device 1 can be reinforced. Further, comparing to the case where the entire antenna base is composed of die-cast, the weight and the cost of the antenna device 1 can be reduced. Furthermore, since the die-cast base 21 and the resin base 22 are integrally molded, an invasive object such as water can be prevented from coming inside the antenna device 1 (antenna cover 10) and inside the vehicle through the joint border between the die-cast base 21 and the resin base 22. Specifically, since the die-cast base 21 is a metallic die-cast, the number of parts can be reduced by one part being responsible for a plurality of functions, the number of working process can be reduced, and the die-cast base 21 can have sufficient rigidity at the time when screwing to attach the antenna device 1 to the vehicle by the protrusion 212.

Further, the protrusion 212 is grounded by being attached to the vehicle. The antenna device 1 includes the antenna board 40 which is electrically connected to the antenna unit 30. The die-cast base 21 includes the board holder 213 which holds the antenna board 40. The board holder 213 is grounded via the protrusion 212. Thus, the antenna board 40 can be held firmly by the board holder 213 of the die-cast base 21 having high rigidity and the ground potential of the antenna board 40 can be obtained easily from the board holders 213.

The resin base 22 includes a plurality of concave units 224. The plurality of concave units 224 are arranged so that the resin part between the plurality of concave units 224 functions as the reinforcement unit. Thus, the weight of the antenna device 1 (resin base 22) can be reduced more and the antenna base 20 (resin base 22) can be reinforced.

The antenna device 1 further includes the gasket 50 which is provided around the resin base 22 and which deforms by the pressure of when attaching the protrusion 212 to the vehicle. Thus, an invasive object such as water can be more prevented from coming inside the antenna device 1 (antenna cover 10) and inside the vehicle.

The antenna device 1 includes the packing 60 which is provided on the back of the antenna base 20 so as to surround the protrusion 212 and the joint border between the die-cast base 21 and the resin base 22 and which deforms by the pressure of when attaching the protrusion 212 to the vehicle. Thus, an invasive object such as water can be further prevented from coming inside the antenna device 1 (antenna cover 10) and inside the vehicle.

The antenna cover 10 further includes the resin-made cover body 11 and the capacitive element 12, at least a part of the capacitive element 12 being embedded in the cover body. The antenna unit 30 includes the helical element 32 and the contact connector 33 which connects the helical element 32 and the capacitive element 12. Thus, the antenna 100 can be configured with the helical element 32 and the capacitive element 12.

According to the above one or more embodiments, an antenna device can be strengthened, the weight and cost of the antenna device can be reduced and an invasive object from the outside can be prevented from coming inside thereof.

Although detail description is given above based on the embodiment made by the inventor, the present invention is not limited to the above embodiment and the present invention can be modified within the scope of the present invention.

For example, the external size of the antenna device 1 can be designed freely as long as the antenna cover is integrally molded with the capacitive element.

In the above embodiment, the antenna cover 10 includes the plate-shape capacitive element 12 which is in a shape conforming to the shape of the antenna cover 10. However, such configuration is not limitative in any way. For example, the antenna cover 10 may include a capacitive element shaped into a wire frame, a spiral wire, or a zig-zag (meandering) shape. In a preferred embodiment, the capacitive element has a shape conforming to the shape of the antenna cover 10. The capacitive element shaped into a wire frame, a spiral wire, or a meandering shape and functioning as a capacitance hat and an inductor generates lower capacitance and has more inductance components than the plate-shape capacitive element. In the embodiment, the capacitive element 12 functions as a capacitance hat and an inductor. However, such configuration is not limitative in any way. Alternatively, the capacitive element may function as a capacitance hat or an inductor.

In the above embodiment, the antenna unit 30 includes the antenna block 31 and the helical element 32 of the conducting wire spirally wound around the antenna block 31. However, such configuration is not limitative in any way. For example, the antenna unit 30 may have an air-core configuration with no antenna block 31 if the conducting wire of the helical element 32 has a rigid spring shape and the like. Alternatively, the antenna unit 30 may include an antenna block 31 and a helical element 32 which is a copper foil having a conductive pattern instead of the conducting wire and disposed on the surface of the antenna block 31, for example.

In the above embodiment, the antenna unit 30 has a middle load structure in which the helical element 32 is disposed and connected midway between the capacitive element 12 and the power feeding point of the antenna board 40. However, such configuration is not limitative in any way. For example, the antenna unit 30 may have a top load structure in which the helical element 32 is disposed and connected very close to the capacitive element 12, or may have a bottom load structure in which the helical element 32 is disposed and connected near the power feeding point of the antenna board 40.

In the above embodiment, the capacitive element 12 is exposed from the inner surface defining the open bottom surface of the antenna cover 10 (cover body 11). However, such configuration is not limitative in any way. For example, the capacitive element may be exposed from the top of the antenna cover (cover body) The exposed part of such a capacitive element should preferably be coated with a protective material which protects the capacitive element. A preferred protective material is a waterproof material, for example, to protect the capacitive element from rain. Such a structure of the capacitive element can increase the height of the antenna including the capacitive element and the helical element and enhance the receiving sensitivity of the antenna device.

The antenna block 31 of the antenna unit 30 may have any shape other than the shapes described in the above embodiment. For example, the antenna block may be a triangular prism which has an isosceles triangle bottom and is laid sideways, an elliptic column, or an oval column. Additionally, the antenna device 1 may have antennas 100 having different functions and disposed along the longitudinal or lateral direction of the antenna device 1.

In the above embodiment, the antenna device 1 includes one antenna 100, the die-cast base 21 and the resin base 22 hold one antenna board 40 and the resin base 22 holds one antenna block 31. However such configuration is not limitative in any way. The antenna device 1 may be a composite antenna device including a plurality of antennas, along with the antenna device 1 being a composite antenna device, the die-cast base 21 may hold antenna boards for the plurality of antennas and may perform earth connection for obtaining ground potential for the plurality of antennas. The resin base 22 may hold an antenna which does not require earth connection and at least one inner structure. The die-cast base 21 and the resin base 22 may hold a plurality of antenna boards.

In the above embodiment, the antenna device 1 includes the antenna 100 which receives radio waves in the frequency bandwidths for FM and AM waves. However, such configuration is not limitative in any way. The antenna 100 may have any configuration to receive waves of any other transmission scheme or waves in any other frequency bandwidth.

The embodiment of the present invention disclosed herein should be considered to be mere examples and not limitative in all respects. The scope of the present invention is defined not by the above descriptions but by the claims, and is intended to cover all the modifications having equivalent meanings to those of the claims or being within the scope of the claims.

This application is based upon and claims the benefit of priority under 35 USC 119 of Japanese Patent Application No. 2015-166602 filed on Aug. 26, 2015, the entire disclosure of which, including the specification, claims, drawings and abstract, is incorporated herein by reference in its entirety.

What is claimed is:

1. An antenna device comprising:
an antenna base;
an antenna cover attached to the antenna base; and
an antenna unit, wherein
the antenna base includes a metallic die-cast base and a resin base,
the die-cast base includes a protrusion which is to be inserted in a fixing opening formed in a vehicle and attached to the vehicle, and
the die-cast base and the resin base are molded integrally.

2. The antenna device according to claim 1, wherein
the protrusion is grounded by being attached to the vehicle,
the antenna device includes an antenna board which is electrically connected to the antenna unit,
the die-cast base includes a board holder which holds the antenna board, and
the board holder is grounded via the protrusion.

3. The antenna device according to claim 1, wherein
the resin base includes a plurality of concave units, and
the plurality of concave units are arranged so that a resin part between the plurality of concave units functions as a reinforcement unit.

4. The antenna device according to claim 1 comprising a gasket which is provided around the resin base and which deforms by a pressure of when attaching the protrusion to the vehicle.

5. The antenna device according to claim 1 comprising a packing which is provided on a back of the antenna base so as to surround the protrusion and a joint border between the die-cast base and the resin base and which deforms by a pressure of when attaching the protrusion to the vehicle.

6. The antenna device according to claim 1, wherein the antenna cover comprises:
a resin cover body; and
a capacitive element, at least apart of the capacitive element being embedded in the cover body, and
the antenna unit comprises:
a helical element; and
a contact connector which connects the helical element and the capacitive element.
